(19) United States
(12) Patent Application Publication
(10) Pub. No.: US 2016/0277888 A1
(43) Pub. Date: Sep. 22, 2016

(54) DISTRIBUTION OF CLOCK DRIFT INFORMATION AMONG WIRELESS DEVICES

(71) Applicant: QUALCOMM Incorporated, San Diego, CA (US)

(72) Inventors: Urs NIESEN, Summit, NJ (US); Venkatesan NALLAMPATTI EKAMBARAM, Somerville, NJ (US); Jubin JOSE, Belle Mead, NJ (US); Xinzhou WU, Hillsborough, NJ (US)

(21) Appl. No.: 14/751,480

(22) Filed: Jun. 26, 2015

Related U.S. Application Data
(60) Provisional application No. 62/133,896, filed on Mar. 16, 2015.

(51) Int. Cl. H04W 4/02; H04L 12/26

(52) U.S. Cl. CPC H04W 4/023; H04L 43/0852

(57) ABSTRACT

Clock drift for range estimation between a first wireless device and a second wireless device is determine before such estimation, while acceptable communication between the first device and the second device is unavailable. While acceptable communication is unavailable, a relative clock drift Δ₀₁ between a relative wireless device and the first device is obtained by the second device; a relative clock drift Δ₂₀ between the second device and the relative wireless device is determined; and a relative clock drift Δ₂₁ between the second device and the first device is estimated based on the relative clock drift Δ₀₁ and the relative clock drift Δ₂₀. Once acceptable communication is available, a distance between the first device and the second device is estimated based on the relative clock drift Δ₂₁.

### CROSS-REFERENCE TO RELATED APPLICATION(S)

This application claims the benefit of U.S. Provisional Application Ser. No. 62/133,896, entitled “DISTRIBUTION OF CLOCK DRIFT INFORMATION AMONG WIRELESS COMMUNICATION DEVICES” and filed on Mar. 16, 2015, which is expressly incorporated by reference herein in its entirety.

### BACKGROUND

1. Field

The present disclosure relates generally to wireless devices, and more particularly, to distribution of clock drift information for range or distance estimation between wireless devices.

2. Background

The time of flight of a wireless signal may be used to estimate the distance between a transmitter and a receiver. In order to transform the time of flight information into a distance estimate, the local clocks at the two devices may be tightly synchronized. Indeed, a nanosecond offset between the two clocks may translate roughly into a 30 cm ranging error. Since nanosecond-level synchronization is difficult to achieve, distances are typically estimated by computing the round-trip time of a signal from a first device to a second device and back to the first one.

If the delay between sending the signal from the first device and replying back from the second device is small, this approach may work well. However, as soon as this delay becomes larger, for example more than 0.1 milliseconds, the relative clock drift of the two local clocks at the devices may become relevant and may be taken into account. This situation arises, for example, if efficient broadcast transmissions are used to estimate all distances between a large number of devices.

As an example, in the dedicated short-range communication (DSRC) standard for vehicular communication, cars broadcast a periodic safety beacon every 100 milliseconds. The time of flight of these periodic safety beacons may be used to estimate relative vehicle distances. However, the typical clock drift during the 100 milliseconds between beacon transmissions may be up to 1 microsecond, assuming a clock accuracy of 10 parts per million (ppm). If not accounted for properly, this clock drift may translate into a ranging error of approximately 300 m. Careful estimation of and accounting for the relative clock drifts is hence advantageous for successful ranging using this approach.

Estimating these relative clock drifts may result in additional delays (e.g., until a distance estimate can be computed). If the clock drift estimates are noisy, clock drift estimates may further degrade the quality of the distance estimates.

### SUMMARY

In an aspect of the disclosure, a method, a computer program product, and an apparatus are provided. When acceptable communication between a first wireless device and a second wireless device is not available, a clock drift for range estimation between a first wireless device and a second wireless device is determine before such estimation. Acceptable communication may be unavailable, for example, when the line of sight between the first device and the second device is blocked, or when the channel between the two devices is noisy or exhibits frequent packet drops. While acceptable communication is unavailable, a relative clock drift Δ₀₁ between a relative wireless device and the first device is obtained by the second device, a relative clock drift Δ₂₀ between the second device and the relative wireless device is determined, and a relative clock drift Δ₂₁ between the second device and the first device is estimated based on the relative clock drift Δ₀₁ and the relative clock drift Δ₂₀. Once acceptable communication between the two devices is available, a distance between the first device and the second device is estimated based on the relative clock drift Δ₂₁.

### BRIEF DESCRIPTION OF THE DRAWINGS

FIG. 1 is an illustration of vehicles and a traffic light and respective lines of sight between the vehicles and traffic light and wireless devices associated therewith.

FIG. 2 is a flow chart of a method of estimating a range between a first wireless device and a second wireless device using distributed clock drift information.

FIG. 3 is a conceptual data flow diagram illustrating the data flow between different modules/means/components in an exemplary apparatus that implements the method of FIG. 2.

FIG. 4 is a diagram illustrating an example of a hardware implementation for an apparatus employing a processing system that implements the method of FIG. 2.

FIG. 5 is an illustration of broadcast message exchange between two wireless devices that provides information for estimating the distance or range between the two devices.

FIG. 6 is a flow chart of a method of estimating a range between a first wireless device and a second wireless device.

FIG. 7 is a conceptual data flow diagram illustrating the data flow between different modules/means/components in an exemplary apparatus that implements the method of FIG. 6.

FIG. 8 is a diagram illustrating an example of a hardware implementation for an apparatus employing a processing system that implements the method of FIG. 6.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

Disclosed herein is a method for distributing clock drift information between devices while, for example, acceptable communication between the devices is unavailable. The clock drift information may be used during range estimation between the devices. Distributing the information during a time when communication between the devices is unacceptable may reduce the delay in estimating distances and improve the quality of range estimates. Communication between two devices may be unacceptable, for example, when the line of sight between the first device and the second device is blocked, or when the channel between the two devices is noisy or exhibits frequent packet drops.

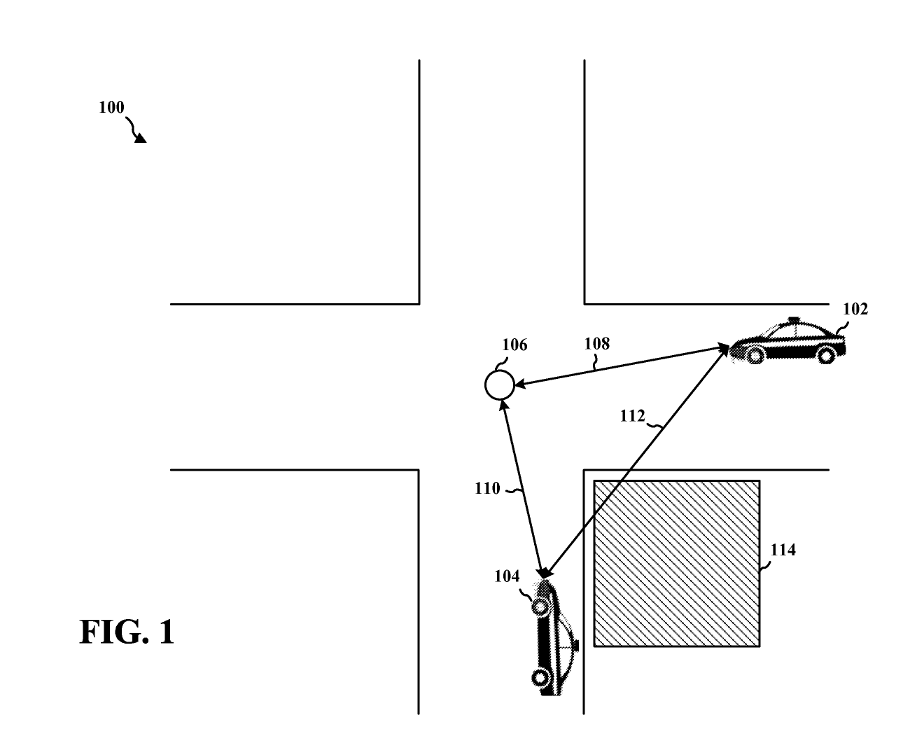

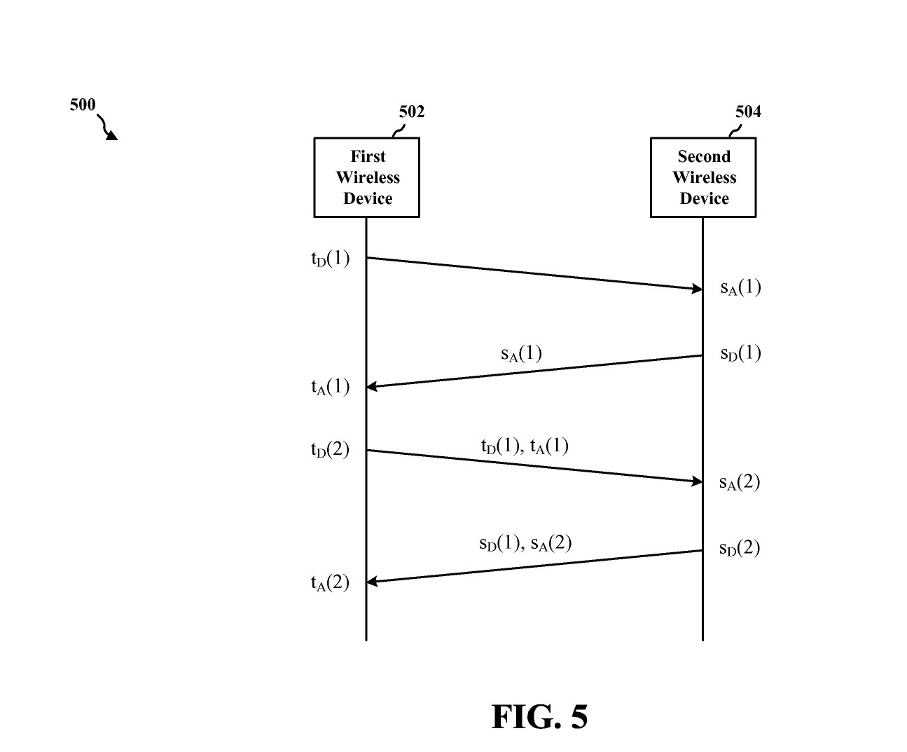

With reference to FIG. 1, consider two cars 102, 104 approaching a red light 106 at an intersection. The first car 102 is equipped with a first wireless device (e.g., wireless communication device). The second car 104 is equipped with a second wireless device (e.g., wireless communication device). The red light 106 is also equipped with a wireless device (e.g., wireless communication device). The wireless device of the red light is referred to herein as a relative wireless device due to its stationary nature relative to the wireless devices of the cars. Each of the wireless devices may be configured to transmit periodic broadcast messages, such as proposed in the DSRC architecture. As described further below with reference to FIGS. 5-8, the broadcast messages may be used to estimate a distance or range between two devices (e.g., the first wireless device and the second wireless device).

With continued reference to FIG. 1, the first car 102 and hence the first wireless device has a clear line of sight 108 to the relative wireless device of the red light 106. The second car 104 and hence the second wireless device also has a clear line of sight 110 to the relative wireless device of the red light 106. The path 112 between the two cars 102, 104 is blocked by a building 114, thereby rendering direct ranging between the wireless devices of the cars difficult.

The local time and the reference time of a wireless device can be related as:

t=Θᵢ+Δᵢtᵢ.
where: t corresponds to a fixed time with respect to a reference clock,
   tᵢ, corresponds to a local time as measured by the local clock of a wireless device i=0, 1, 2, where device 0 denotes the wireless device associated with the red light 106, device 1 denotes the first wireless device associated with the first car 102, and device 2 denotes the second wireless device associated with the second car 104,
   Θᵢ is the clock offset, and
   Δᵢ is equal to 1 plus the clock drift (for simplicity simply referred to as clock drift in the following).

The local times tᵢ and tᵢ at two different devices are then related as:

$${t}_{i} = \frac{{Θ}_{j} - {Θ}_{i}}{{Δ}_{i}} + \frac{{Δ}_{j}}{{Δ}_{i}} {t}_{j} = {Θ}_{ij} + {Δ}_{ij} {t}_{j} ,$$

where Θᵢⱼ and Δᵢⱼ are the relative clock offset and relative clock drift, respectively.

From the periodic broadcast transmissions, the wireless device associated with the red light 106 is able to accurately estimate the relative clock drift Δ₀₁ between itself and the first wireless device associated with the first car 102. Similarly, the wireless device associated with the second car 104 is able to accurately estimate the relative clock drift Δ₂₀ between itself and the wireless device associated with the red light 106. However, due to the blocked path 112 (e.g., line of sight), the second wireless device associated with the second car 104 may be unable to estimate the relative clock drift Δ₂₁ between itself and the first wireless device associated with the first car 102.

Once the cars 102, 104 clear the building 114, the second wireless device associated with the second car 104 may estimate (either explicitly or implicitly) this relative clock Δ₂₁ drift in order to estimate its distance to the first wireless device associated with the first car 102. Having to wait for a clear line of sight between the first and second wireless devices may lead to delays of several hundred milliseconds before the distance estimate can be produced. Moreover, if the relative clock drift Δ₂₁ is estimated from only a few broadcast messages, then this estimate may be noisy and result in inaccurate estimates of the vehicle distance.

As disclosed herein, relative clock drifts may be disseminated among the wireless devices associated with vehicles, e.g., the first car 102 and the second car 104, and fixed infrastructure devices, e.g., the red light 106, to help alleviate the foregoing problems. Applying the disclosed approach to the scenario shown in FIG. 1, the wireless device associated with the red light 106 may transmit its relative clock drift Δ₀₁ to the second wireless device associated with the second car 104. The second wireless device associated with the second car 104 may then compute the desired estimate of the relative clock offset Δ₂₁ between itself and the first wireless device associated with the first car 102 as follows:

Δ₂₀·Δ₀₁=Δ₂₁

Since the estimates of clock offset Δ₂₀ and clock offset Δ₀₁ may be estimated over many broadcast messages, those estimates may be accurate, resulting in an accurate estimate of clock offset Δ₂₁. Furthermore, since the wireless device associated with the red light 106 may start disseminating its locally estimated relative clock drift before the two wireless devices associated with the cars 102, 104 have a line of sight (e.g., path 112), this accurate estimate may be obtained without any delay in estimating the distances between the two cars.

The proposed approach may be generalized to more complicated scenarios. For example, from relative clock drift estimates Δᵢ_{₁}ᵢ_{₂}, Δᵢ_{₂}ᵢ_{₃}, . . . , Δᵢ_{_{L−1}}ᵢ_{_{L}} either locally estimated or received from other devices, the device i₁ may compute the estimate of the relative clock drift between itself and another device i_{L} as follows:

$${Δ}_{{i}_{1} {i}_{L}} = {\prod }_{l = 1}^{L - 1} {Δ}_{{i}_{l} {i}_{l + 1}}$$

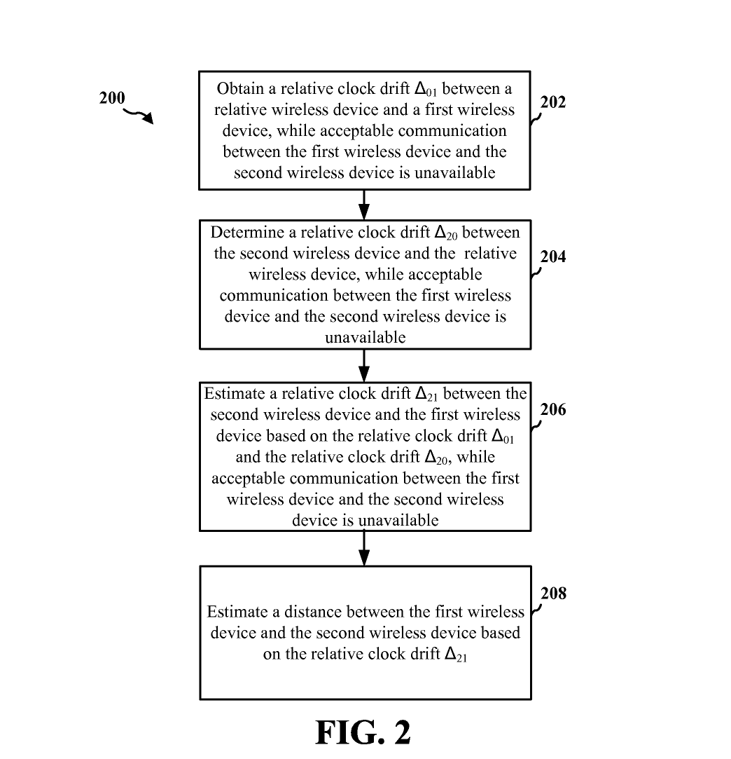

FIG. 2 is a flow chart 200 of a method of estimating a range between a first wireless device and a second wireless device. For example, the method may be performed by the second wireless device associated with the second car 104 in FIG. 1.

At 202, the second wireless device obtains a relative clock drift Δ₀₁ between a relative wireless device and a first wireless device, while acceptable communication between the first wireless device and the second wireless device is unavailable. For example, referring to FIG. 1, the first wireless device may be the wireless device associated with the first car 102; the second wireless device may be the wireless device associated with the second car 104; and the relative wireless device may be the wireless device associated with the red light 106. Communication may be deemed unacceptable when a communication channel between the devices cannot be established (failing to establish the communication channel). In other cases, even if a communication channel can be established between the device, the communication may still be deemed unacceptable because it is not accurate for clock drift estimation due to, for example, a blocked line of sight or unacceptable channel quality metrics. For example, the channel may be too noisy (e.g., exceeding a noise threshold) or exhibits frequent packet drops (e.g., exceeding a drop threshold), which may cause the unacceptable channel quality metrics. The relative clock drift Δ₀₁ may be received from the relative wireless device, which calculates the clock drift based on broadcast transmissions from the first wireless device. The relative clock drift Δ₀₁ may be determined for example, using least-squares estimation known in the art.

At 204, the second wireless device determines a relative clock drift Δ₂₀ between the second wireless device and the relative wireless device, while acceptable communication between the first wireless device and the second wireless device is unavailable. The relative clock drift Δ₂₀ may be determined for example, using least-squares estimation, which is known in the art.

At 206, the second wireless device estimates a relative clock drift Δ₂₁ between the second wireless device and the first wireless device based on the relative clock drift Δ₀₁ and the relative clock drift Δ₂₀, while acceptable communication between the first wireless device and the second wireless device is unavailable. The relative clock drift Δ₂₁ may be determined as follows:

Δ₂₀·Δ₀₁=Δ₂₁

At 208, the second wireless device estimates a distance between the first wireless device and the second wireless device based on the relative clock drift Δ₂₁. Such estimation may occur once an acceptable channel of communication between the device is available. In some examples, the distance may be estimated further based on an exchange of broadcast messages as described below with reference to FIGS. 5-8.

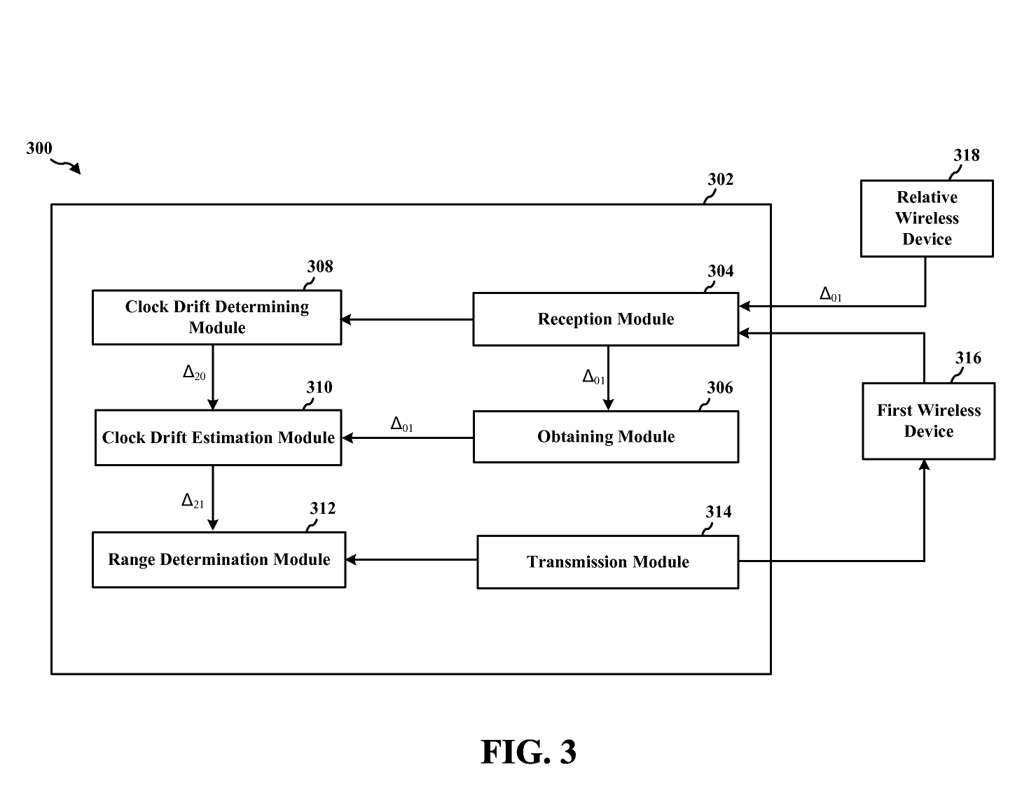

FIG. 3 is a conceptual data flow diagram 300 illustrating the data flow between different modules/means/components in an exemplary apparatus 302. The apparatus 302 may be a second wireless device configured to estimate a range between itself and a first wireless device 316. In one example, the exemplary apparatus 302 may correspond to the wireless device associated with the second car 104, and the first wireless device 316 may correspond to the wireless device associated with the first car 102. The apparatus 302 includes a reception module 304, an obtaining module 306, a clock drift determining module 308, a clock drift estimation module 310, a range determination module 312, and a transmission module 314.

The reception module 304 receives messages transmitted by the first wireless device 316 and a relative wireless device 318. The transmission module 314 transmits messages from the apparatus 302 (e.g., second wireless device). For example, the transmission module 314 may transmit information to the first wireless device 316 to enable the first wireless device 316 to obtain the clock drifts, and may transmit messages for estimating distances as described with FIGS. 5-8 below.

The obtaining module 306 obtains a relative clock drift Δ₀₁ between the relative wireless device 318 and a first wireless device 316, while acceptable communication between the first wireless device 316 and the apparatus 302 (e.g., second wireless device) is unavailable. For example, the obtaining module 306 may implement the least-squares estimation to obtain the relative clock drift Δ₀₁.

The clock drift determining module 308 determines a relative clock drift Δ₂₀ between the apparatus 302 (e.g., second wireless device) and the relative wireless device 318, while acceptable communication between the first wireless device 316 and the apparatus 302 (e.g., second wireless device) is unavailable. For example, the clock drift determining module 308 may implement the least-squares estimation to obtain the relative clock drift Δ₂₀.

The clock drift estimation module 310 estimates a relative clock drift Δ₂₁ between the apparatus 302 (e.g., second wireless device) and the first wireless device 316 based on the relative clock drift Δ₀₁ and the relative clock drift Δ₂₀, while acceptable communication between the first wireless device 316 and the apparatus 302 (e.g., second wireless device) is unavailable. For example, the clock drift estimation module 310 may obtain the relative clock drift Δ₂₁ as follows:

Δ₂₀·Δ₀₁=Δ₂₁.

The range determination module 312 estimates a distance between the first wireless device 316 and the apparatus 302 (e.g., second wireless device) based on the relative clock drift Δ₂₁ and an exchange of wireless signals between the first wireless device 316 and the apparatus 302 (e.g., second wireless device). For example, the range determination module 312 may implement the ranging scheme described with FIGS. 5-8 below.

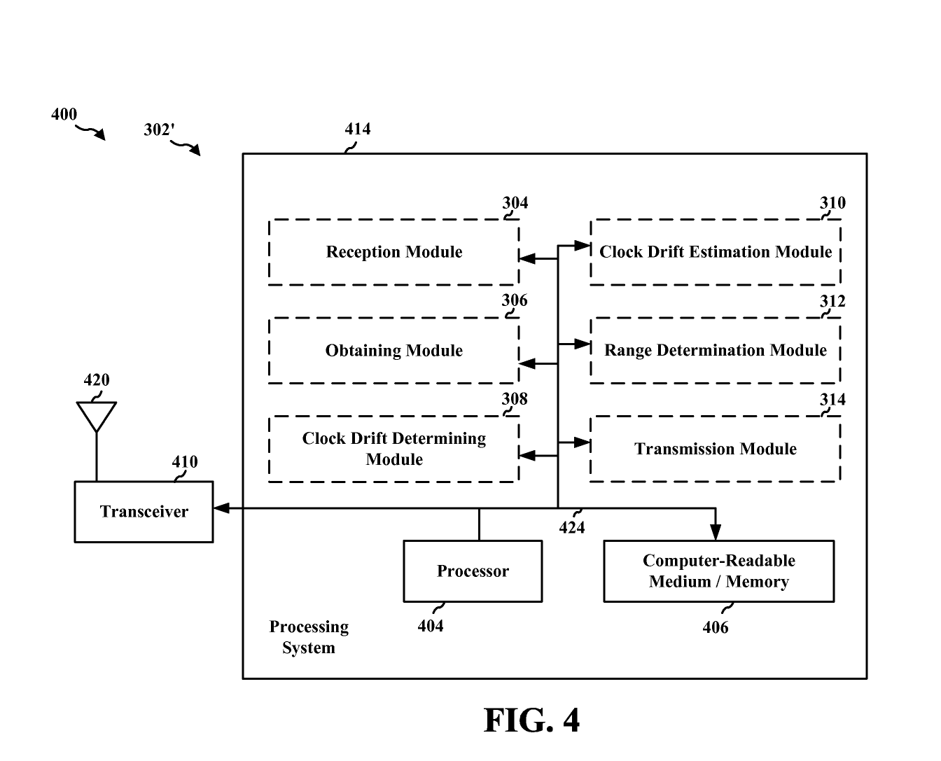

FIG. 4 is a diagram 400 illustrating an example of a hardware implementation for an apparatus 302′ employing a processing system 414. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware modules, represented by the processor 404, the modules 304, 306, 308, 310, 312, 314 and the computer-readable medium/memory 406. The bus 424 may also link various other circuits such as timing sources, peripherals, voltage regulators, and power management circuits, which are well known in the art, and therefore, will not be described any further.

The processing system 414 may be coupled to a transceiver 410. The transceiver 410 is coupled to one or more antennas 420. The transceiver 410 provides a means for communicating with various other apparatus over a transmission medium. The transceiver 410 receives a signal from the one or more antennas 420, extracts information from the received signal, and provides the extracted information to the processing system 414, specifically the reception module 304. In addition, the transceiver 410 receives information from the processing system 414, specifically the transmission module 314, and based on the received information, generates a signal to be applied to the one or more antennas 420.

The processing system 414 includes a processor 404 coupled to a computer-readable medium/memory 406. The processor 404 is responsible for general processing, including the execution of software stored on the computer-readable medium/memory 406. The software, when executed by the processor 404, causes the processing system 414 to perform the various functions described supra for any particular apparatus. The computer-readable medium/memory 406 may also be used for storing data that is manipulated by the processor 404 when executing software. The processing system further includes at least one of the modules 304, 306, 308, 310, 312, and 314. The modules may be software modules running in the processor 404, resident/stored in the computer readable medium/memory 406, one or more hardware modules coupled to the processor 404, or some combination thereof.

In one configuration, the apparatus 302/302′ for wireless communication includes means for obtaining a relative clock drift Δ₀₁ between a relative wireless device and a first wireless device, while acceptable communication between the first wireless device and the second wireless device is unavailable; means for determining a relative clock drift Δ₂₀ between the second wireless device and the relative wireless device, while acceptable communication between the first wireless device and the second wireless device is unavailable; means for estimating a relative clock drift Δ₂₁ between the second wireless device and the first wireless device based on the relative clock drift Δ₀₁ and the relative clock drift Δ₂₀, while acceptable communication between the first wireless device and the second wireless device is unavailable; and means for estimating a distance between the first wireless device and the second wireless device based on the relative clock drift Δ₂₁ and an exchange of wireless signals between the first wireless device and the second wireless device. The aforementioned means may be one or more of the aforementioned modules of the apparatus 302 and/or the processing system 414 of the apparatus 302′ configured to perform the functions recited by the aforementioned means.

From the perspective of the relative wireless device, a process may involve the relative wireless device determining that acceptable communication between the first wireless device and the second wireless device is unavailable. For example, the relative wireless device may receive information from either of the first or second wireless devices indicating that a communication channel cannot be established between the devices or that the quality of an existing channel below acceptable levels. Alternatively, the relative device may know based on location information of the two devices that communication is unavailable, e.g., blocked line of sight. Upon such determination the relative wireless device may proceed to distribute the clock information as described above.

FIG. 5 is an illustration 500 of broadcast message exchange between two wireless devices 502, 504 that provides information for estimating the distance or range between the two devices. An example of the first wireless device 502 may be the wireless device of the second car 104, and the second wireless device 504 may be the wireless device of the first car 102. For example, the first wireless device 502 may compute a range to the second wireless device 504 from the following timing information (e.g., as part of the operation 208):

1. Timestamps associated with the first wireless device 502 broadcast messages, including for example:
a. ToDs of messages broadcasted by the first wireless device (t_{D}(n)), as recorded by the first wireless device.
b. ToAs of messages broadcasted by the first wireless device and received by the second wireless device (s_{A}(n)), which are obtained by the first wireless device from messages subsequently broadcasted by the second wireless device.

2. Timestamps associated with the second wireless device 504 broadcast messages, including for example:
a. ToDs of messages broadcast by the second wireless device (s_{D}(n)), as recorded by the second wireless device, which are obtained by the first wireless device from messages subsequently broadcasted by the second wireless device.
b. ToAs of messages broadcast by the second wireless device and received by the first wireless device (t_{A}(n)), as determined by the first wireless device.

While range is computed, the first wireless device 502 needs to account for relative clock drift between the clock of the first wireless device and the clock of the second wireless device, and the mobility, if any, of the devices. Both relative clock drift and mobility change slowly over time and hence low-order models can be utilized. Low-order models reduce the number of unknown parameters and hence make range estimation feasible. Some specific examples for low-order models include: 1) Relative clock drift could be approximated by a linear model, and 2) Range between two devices could be approximated by a quadratic model.

The parameters associated with the above models or other low-order models need to be re-estimated based on the time-scales involved. The algorithm for joint estimation of these parameters may include weighted local polynomial regression:

For example, at time tₐ(n), the following equations may be used to jointly solve for clock drift δ and distance dₐ(n): Minimize:

(cΔsₐ(n)−(1+δ)cΔt_{d}(n)−a₁t_{d}(n)−a₂t_{d}²(n)+a₁t_{d}(n−1)+a2td2n−12

+(cΔs_{d}(n)−(1+δ)cΔtₐ(n)−2a₀−a₁t_{d}(n)−a₂t_{d}²(n)−a1 tan−1−a2ta2(n−1)2

+ . . . +(cΔsₐ(n−w)− . . . )²+(cΔs_{d}(n−w)− . . . )²
where w is the window length.

Can be written in matrix form: Minimize

∥β−Bx∥²

β=c[Δsₐ(n−w:n)−Δt_{d}(n−w:n);Δs_{d}(n−w:n)−Δtₐ(n−w:n)]

B=[Δt_{d}(n−w:n),0,t_{d}(n−w:n)−t_{d}(n−w−1:n−1),t_{d}²(n−w:n−td2n−w−1:n−1;

Δtₐ(n−w:n),2,t_{d}(n−w:n)+tₐ(n−w−1:n−1),t_{d}²(n−w:n+ta2n−w−1:n−1]

x=[cδ;a₀;a₁;a₂]

Closed-form solution

\hat{x}=(B^{T}B)⁻¹B^{T}β

From this, the distance estimate is

\hat{d}ₐ(n)=a₀+a₁tₐ(n)+a₂tₐ²(n)

Reasonable to give less weight to old measurements
Normalize time offset by window size
Let W be diagonal weight matrix, example, use tricube weight function
Weighted least-squares solution

\hat{x}=(B^{T}WB)⁻¹B^{T}Wβ

In an alternate method, all devices calculate ToD and ToA timestamps with respect to a reference clock. For example, this reference clock could be associated with a selected cluster head. Note that only clock drift correction is required for the above method. Time offset correction is difficult to achieve to the accuracy required and is not required in the method described.

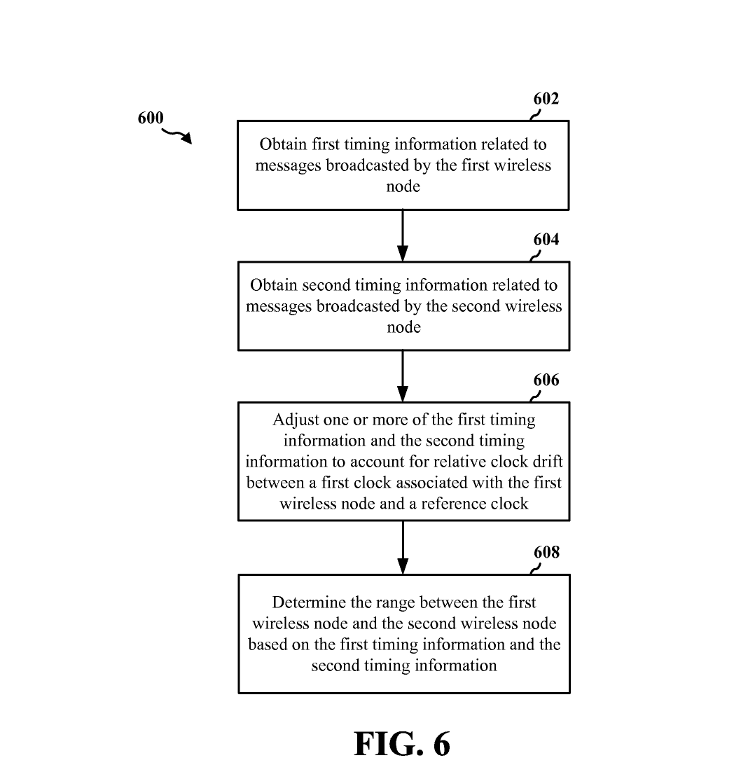

FIG. 6 is a flow chart of a method of estimating a range between a first wireless device 502 and a second wireless device 504. The method may be performed by the first wireless device 502.

At 602, first timing information of messages broadcasted by the first wireless device 502 is obtained. The first timing information may include, for each message broadcasted by the first wireless device, a time of departure of the message from the first wireless device (t_{D}). The t_{D} may be recorded by the first wireless device. The first timing information may also include, for each message broadcasted by the first wireless device, a time of arrival of the message at the second wireless device (s_{A}). The s_{A} may be determined by the second wireless device at receipt of the message and subsequently included in a message broadcasted by the second wireless device. The first timing information may further include identification information for the first wireless device.

The first timing information received by the first wireless device 402 in a broadcast message may be compressed. For example, the timestamps in the broadcast messages may be compressed by the wireless device that transmits the message by, for example, transmitting only the least significant bits of the timing information. On the receiving end, the first wireless device 402 may reconstruct the most significant bits of the timing information based on prior coarse positional information.

At 604, second timing information of messages broadcasted by the second wireless device is obtained. The second timing information may include, for each message broadcasted by the second wireless device, a time of departure of the message from the second wireless device (s_{D}). The sp may be recorded by the second wireless device and included in a message broadcasted by the second wireless device. The second timing information may also include, for each message broadcasted by the second wireless device, a time of arrival of the message at the first wireless device (t_{A}). The t_{A} may be determined by the first wireless device at receipt of the message, and subsequently included in a message broadcasted by the second wireless device. The second timing information may further include identification information for the second wireless device.

The second timing information received by the first wireless device 402 in a broadcast message may be compressed. For example, the timestamps in the broadcast messages may be compressed by the wireless device that transmits the message by, for example, transmitting only the least significant bits of the timing information. On the receiving end, the first wireless device 402 may reconstruct the most significant bits of the timing information based on prior coarse positional information.

At 606, one or both of the first timing information and the second timing information may be adjusted to account for relative clock drift between a first clock associated with the first wireless device and a reference clock. The reference clock may be a second clock associated with the second wireless device. The reference clock may be selected based on a signaling exchange between the first wireless device and the second wireless device.

At 608, the range between the first wireless device and the second wireless device based on the first timing information and the second timing information is determined. The clock drift and range may be determined using: low-order model for clock drift, e.g., linear model; low-order model for range, e.g., quadratic model; jointly compute clock drift and range, e.g., weighted local linear regression, such as shown in the equations above and by the equations in Appendix A.

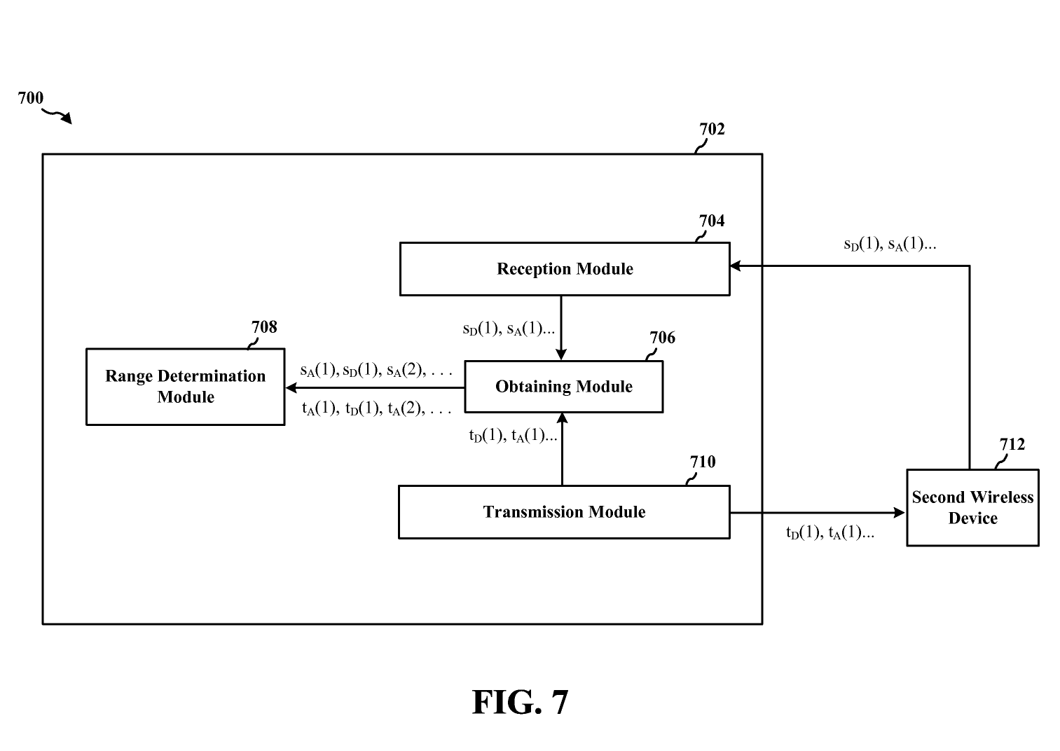

FIG. 7 is a conceptual data flow diagram 700 illustrating the data flow between different modules/means/components in an exemplary apparatus 702. The apparatus may be a first wireless device configured to estimate a range between itself and a second wireless device 712. The apparatus 702 includes a reception module 704, an obtaining module 706, a range determination module 708, and a transmission module 710.

The reception module 704 receives messages broadcasted by the second wireless device 712. The transmission module 710 transmits broadcast messages from the apparatus 702 (e.g., first wireless device).

The obtaining module 706, obtains first timing information related to messages broadcasted by the first wireless device; and second timing information related to messages broadcasted by the second wireless device 712. The information may be obtained from messages received by the reception module 704. For example, the messages may include timestamps or packets that include the information. The information may also be obtained locally based on the broadcasting of messages by the transmission module 710, or the receiving of messages by the reception module 704. For example, the obtaining module 706 may record the time of departure of messages transmitted by the transmission module 710 or the time of arrival of messages received by the reception module 704.

The range determination module 708 determines the range between the apparatus 702 (e.g., first wireless device) and the second wireless device 712 based on the first timing information and the second timing information.

The apparatus 702 may include additional modules that perform each of the blocks of the algorithm in the aforementioned flow chart of FIG. 6. As such, each block in the aforementioned flow charts of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

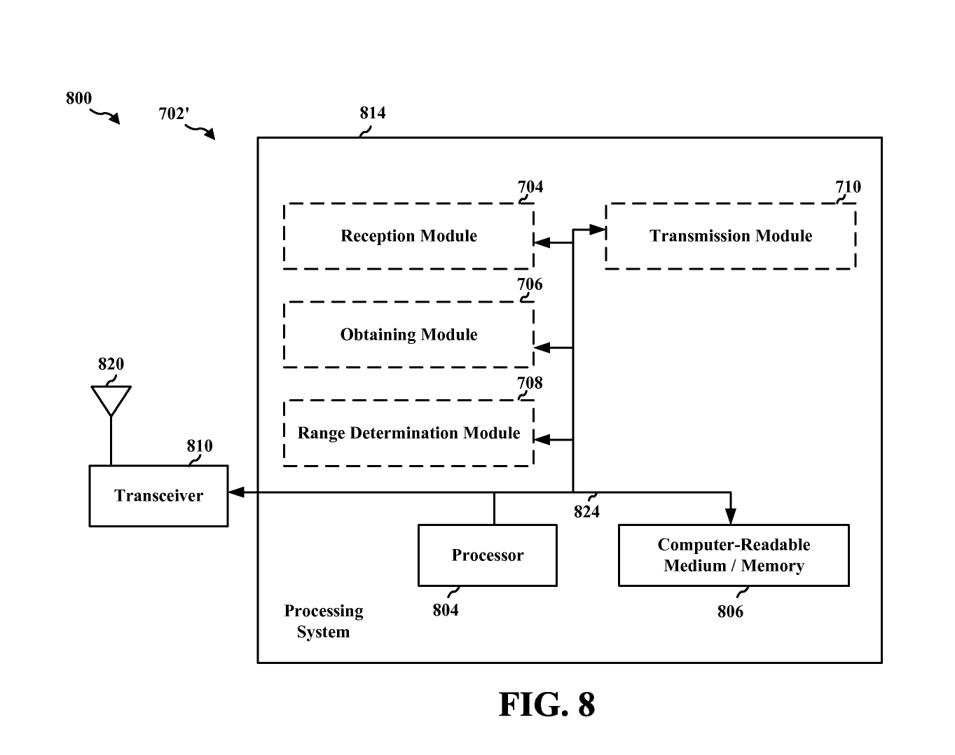

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, 710 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception module 704. In addition, the transceiver 810 receives information from the processing system 814, specifically the transmission module 710, and based on the received information, generates a signal to be applied to the one or more antennas 820.

The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system further includes at least one of the modules 704, 706, 708, and 710. The modules may be software modules running in the processor 804, resident/stored in the computer readable medium/memory 806, one or more hardware modules coupled to the processor 804, or some combination thereof

In one configuration, the apparatus 702/702′ for wireless communication includes means for obtaining first timing information related to messages broadcasted by the first wireless device, means for obtaining second timing information related to messages broadcasted by the second wireless device, means for determining the range between the first wireless device and the second wireless device based on the first timing information and the second timing information, and means for adjusting one or more of the first timing information and the second timing information to account for relative clock drift between a first clock associated with the first wireless device and a reference clock. The aforementioned means may be one or more of the aforementioned modules of the apparatus 702 and/or the processing system 814 of the apparatus 702′ configured to perform the functions recited by the aforementioned means.

FIG. 5 is an illustration 500 of broadcast message exchange between two wireless devices 502, 504 that provides information for estimating the distance or range between the two devices. The message exchange of FIG. 5 may correspond to the first mechanism or process for estimating a range using a first communication channel, as shown in FIGS. 1 and 2. In one implementation, the message exchange of FIG. 5 may be suitable for operating within the DSRC environment. The DSRC provides periodic broadcasting of safety messages by every vehicle, and the wireless devices 502 and 504 may be within the vehicles. In one example, the messages of the message exchange of FIG. 5 may be added to the packets within the DSRC messages. In this fashion, the number of messages broadcast scales linearly with the number of vehicles.

Accordingly, in some embodiments, the message exchange of FIG. 5 includes periodic broadcast in accordance with, for example, DSRC messages. Referring to FIG. 5, the wireless devices 502 and 502 broadcast the messages in periods of T seconds. In some example, the period T corresponds to the period of the DSRC safety message of 0.1 second.

With continued reference to FIG. 5, the first wireless device 502 may compute a range to the second wireless device 504 from the following timing information (which may be added to the DSRC messages):

1. Timestamps associated with the first wireless device 502 broadcast messages, including for example:
a. Departure times of messages broadcasted by the first wireless device 502 (t_{D}(n)), as recorded by the first wireless device 502.
b. Arrival times of messages broadcasted by the first wireless device 502 and received by the second wireless device 504 (s_{A}(n)), which are obtained by the first wireless device 502 from messages subsequently broadcasted by the second wireless device 504.

2. Timestamps associated with the second wireless device 504 broadcast messages, including for example:
a. Departure times of messages broadcast by the second wireless device 504 (S_{D}(n)), as recorded by the second wireless device 504, which are obtained by the first wireless device 502 from messages subsequently broadcasted by the second wireless device 504.
b. Arrival times of messages broadcast by the second wireless device 504 and received by the first wireless device 502 (t_{A}(n)), as determined by the first wireless device 502.

While range is computed, the first wireless device 502 may account for relative clock drift between the clock of the first wireless device 502 and the clock of the second wireless device 504, and the mobility, if any, of the devices. In some embodiments, a local time “t” may correspond to the local time of the first wireless device 502, and the remote time “s” may correspond to the local time of the second wireless device 504. The local times satisfy the following linear relationship:

s(t)=Ø+(1+δ)t,

where Ø is the clock offset, and δ is the clock drift. An example of the clock drift δ is +10⁻⁵, which may be expressed as 10 part per million (ppm).

In one example, the delay between a message departure and the following message arrival is on the order of T/2. Hence, the clock drift during this period is on the order of δT/2. For example, in DSRC, T=0.1 s, and the drift of a 10 ppm clock during that time is on the order of 0.5 ms. In this example, the clock drift of 0.5 ms would result in a ranging error of approximately 150 m. For ranging accuracy on the order of 0.3 m, the uncompensated clock drift δ may at most be 0.01 ppm between successive samples. In the example, the clock drift δ may be modeled as a constant within a window “w” of a few seconds (corresponding to a few tens of DSRC message exchanges).

The arrival and departure timestamps may be described as follows:

s_{A}(n)=Ø+(1+δ)t_{D}(n)+d_{D}(n)/c+z_{A}(n),

s_{D}(n)=Ø+(1+δ)t_{A}(n)d_{A}(n)/c+z_{D}(n),

where d_{D}(n) and d_{A}(n) are the distances between the wireless devices 502 and 504 (e.g., inter-vehicle distances) at times t_{D}(n) and t_{A}(n), c is the speed of light, and z_{A}(n) and z_{D}(n) are additive receiver noise terms. In some examples, the z_{A}(n) and z_{D}(n) are independent and identically distributed random variables (e.g., i.i.d.) with mean zero and σ². The above relationships of s_{A}(n) and s_{D}(n) link the departure and arrival timestamps to the distances between the wireless devices 502 and 504 (e.g., inter-vehicle distances). Because of the movement of the vehicles, these distances may be time-varying (e.g., change as a function of n). Since the vehicle distances may change by several tens of meters per second, this time-varying nature of the distances may be taken into account when using periodic packet broadcasts for ranging. For example, in DSRC with T=0.1 s, the change in distances may be on the order of several meters between successive message arrivals.

As described above, at the arrival time t_{A}(n) of the message n at the first wireless device 502 (e.g., local vehicle), the device or vehicle has access to all locally measured timestamps t_{D}(i) and t_{D}(i) with i≦n. From the received messages, the first wireless device 502 (e.g., local vehicle) has also access to the remotely measured timestamps s_{A}(i) with i≦n and s_{D}(i) with i≦n. The s_{D}(n) may not available at the first wireless device 502 or local vehicle at time t_{A}(n) due to hardware limitations. The periodic ranging may estimate the distance d_{A}(n) at the t_{A}(n), as described below.

The local time t and the remote time s are related through clock offset Ø and a clock drift δ. The timestamp differences may be defined as follows:

Δt_{D}(n)=t_{D}(n)−t_{D}(n−1),

Δs_{A}(n)=s_{A}(n)−s_{A}(n−1),

Δt_{A}(n)=t_{D}(n)−t_{A}(n−1),

Δs_{D}(n)=s_{A}(n)−s_{D}(n−1).

The above quantities are defined such that, for index n, they are all available at the local vehicle at time t_{A}(n). Moreover, the above timestamp relationships may be written as follows:

Δs_{A}(n)=(1+δ)Δt_{D}(n)+(d_{D}(n)−d_{D}(n−1))/c+Δz_{A}(n),

Δs_{D}(n)=(1+δ)Δt_{A}(n)+(d_{D}(n)−d_{A}(n−1))/c+Δz_{D}(n),

with the following definitions:

Δz_{A}(n)=z_{A}(n)−z_{A}(n−1),

Δz_{D}(n)=z_{A}(n)−z_{D}(n−1).

Thus, the transformed measurements are invariant with respect to the clock offset Ø.

Both relative clock drift δ and mobility change slowly over time, and hence, low-order models may be utilized. Low-order models reduce the number of unknown parameters and hence make range estimation feasible. Some specific examples for low-order models include: 1) Relative clock drift could be approximated by a linear model, and 2) Range between two devices could be approximated by a quadratic model. The parameters associated with the above models or other low-order models need to be re-estimated based on the time-scales involved. The algorithm for joint estimation of these parameters may include weighted local polynomial regression:

For example, at time t_{A}(n), the following equations may be used to jointly solve for clock drift δ and distance d_{A}(n): Minimize:

(cΔs_{A}(n)−(1+δ)cΔt_{D}(n)−a₁t_{D}(n)−a₂t_{D}²(n)+a₁t_{D}(n−1)+a2tD2n−12

+(cΔs_{D}(n)−(1+δ)cΔt_{A}(n)−2a₀−a₁t_{D}(n)−a₂t_{D}²(n)a1 tAn−1−a2tA2(n−1)2

+ . . . +(cΔs_{A}(n−w)− . . . )²+(cΔs_{D}(n−w)− . . . )²
where w is the window length.

Can be written in matrix form: Minimize

∥β−Bx∥²

β=c[Δs_{A}(n−w:n)−Δt_{D}(n−w:n);Δs_{D}(n−w:n)−Δt_{A}(n−w:n]

B=[Δt_{D}(n−w:n),0,t_{D}(n−w:n)−t_{D}(n−w−1:n−1),t_{D}²(n−w:n−tD2n−w−1:n−1;

Δt_{A}(n−w:n),2,t_{D}(n−w:n)+t_{A}(n−w−1:n−1),t_{D}²(n−w:n)+t_{A}²(n−w−1:n−1)]

x=[cδ;a₀,a₁;a₂]

Closed-form solution

\hat{x}=(B^{T}B)⁻¹B^{T}β

From this, the distance estimate is

\hat{d}_{A}(n)=a₀+a₁t_{A}(n)+a₂t_{A}²(n)

Reasonable to give less weight to old measurements
Normalize time offset by window size
Let W be diagonal weight matrix, example, use tricube weight function
Weighted least-squares solution

\hat{x}=(B^{T}WB)⁻¹B^{T}Wβ

In some examples, the window size w may be at least two for the matrix B^{T}B to be invertible. Larger values of w may result in larger noise suppression. On the other hand, too large a value of w may lead to biased estimates. In the DSRC setting, w=8 may be a reasonable value. Alternatively, the window size w may be selected adaptively.

In an alternate method, all devices calculate departure time and arrival timestamps with respect to a reference clock. For example, this reference clock could be associated with a selected cluster head. Note that only clock drift correction is required for the above method. Time offset correction is difficult to achieve to the accuracy required and is not required in the method described.

An exemplary of a method to compress the measured timestamps to reduce the overhead of communicating is provided below. The compression of the timestamps may include discarding the most significant bits. Since each wireless device (e.g., vehicle including the wireless device) gets periodic ranging estimates, an approximate distance estimate at the current time is known, which correspond to the higher-order bits. Accordingly, only the lower-order bits may be used to enhance the estimation accuracy.

For example, denote [Δs_{A}(n)] as the compressed timestamp corresponding to Δs_{A}(n). Then the [Δs_{A}(n)] may be defined as:

[Δs_{A}(n)]=10⁹Δs_{A}(n)mod 2^{L},

for a fixed positive integer L. Assuming that Δs_{A}(n) is measured in integer nanoseconds, then the quantity [Δs_{A}(n)] may be encoded using L bits. These L bits may then be transmitted from the second wireless device 504 to the first wireless device 502.

To recover Δs_{A}(n) from [Δs_{A}(n)], the following relationship may be utilized:

10⁹×Δs_{A}(n)=[Δs_{A}(n)]+k_{A}2^{L}

for an integer k_{A}. The integer k_{A} may be estimated as follows:

$${\hat{k}}_{A} ( n ) = ⌊ ( {10}^{9} \frac{Δ {t}_{D} ( n )}{Δ {t}_{D} ( n - 1 )} Δ {s}_{A} ( n - 1 ) - [ Δ {s}_{A} ( n ) ] / {2}^{L} ⌉ ,$$

where the operator └.┘rounds to the closest integer. If the number of bits L is larger than log(2×10⁹ρ×Δt_{D}(n)), then \hat{k}_{A}(n) may equal to k_{A}(n). Accordingly, Δs_{A}(n) may be recovered from the compressed value [Δs_{A}(n)].

In the DSRC example, L>7.7 provides that 8 bits are sufficient to transmit [Δs_{A}(n)]. In some examples, the IEEE 802.11mc defines a Fine-Timing-Measurement (FTM) protocol of 6 bytes for RTT ranging in the WiFi signal spectrum. Thus, instead of transmitting 6 bytes as in the FTM standard, only need 1 byte may be used with the above compression method. In some examples, L of 12 bits may be used to handle situations with dropped or non-line-of-sight measurements.

To initiate the recovery of Δs_{A}(n) from [Δs_{A}(n)], the initial measurement s_{A}(1) may be transmitted uncompressed. Alternatively, [Δs_{A}(1)] and [Δs_{A}(2)] may be decompressed jointly by solving a Diophantine approximation problem. In some implementations, the compression and decompression of timestamps such as Δs_{D}(n), Δt_{A}(n), Δt_{D}(n) may be performed analogously. In some embodiments, the ranging request packets as described above, may be transmitted in the 5.2 GHz Wi-Fi band at a bandwidth of 80 MHz.

FIG. 6 is a flow chart of a method 600 of estimating a range between a first wireless device 502 and a second wireless device 504. The method may be performed by the first wireless device 502. In some implementations, the range determination module 312 may perform the method 600 as the operation 202 of the flow chart 200.

At 602, first timing information of messages broadcasted by the first wireless device 502 is obtained. The first timing information may include, for each message broadcasted by the first wireless device, a time of departure of the message from the first wireless device (t_{D}). The time of departure t_{D} may be recorded by the first wireless device 502. The first timing information may also include, for each message broadcasted by the first wireless device 502, a time of arrival of the message at the second wireless device (s_{A}). The time of arrival s_{A} may be determined by the second wireless device 504 at receipt of the message and subsequently included in a message broadcasted by the second wireless device 504. The first timing information may further include identification information for the first wireless device.

The first timing information received by the first wireless device 502 in a broadcast message may be compressed. For example, the timestamps in the broadcast messages may be compressed by the wireless device that transmits the message by, for example, transmitting only the least significant bits of the timing information. On the receiving end, the first wireless device 502 may reconstruct the most significant bits of the timing information based on prior coarse positional information. The compression scheme may include, for example, recovering Δs_{A}(n) from the L bits compressed timestamps [Δs_{A}(n)] as described with FIG. 5.

At 604, second timing information of messages broadcasted by the second wireless device 504 is obtained. The second timing information may include, for each message broadcasted by the second wireless device 504, a time of departure of the message from the second wireless device (S_{D}). The time of departure S_{D} may be recorded by the second wireless device 504 and included in a message broadcasted by the second wireless device 504. The second timing information may also include, for each message broadcasted by the second wireless device 504, a time of arrival of the message at the first wireless device (t_{A}). The time of arrival t_{A} may be determined by the first wireless device 502 at receipt of the message, and subsequently included in a message broadcasted by the second wireless device 504. The second timing information may further include identification information for the second wireless device 504.

The second timing information received by the first wireless device 502 in a broadcast message may be compressed. For example, the timestamps in the broadcast messages may be compressed by the wireless device that transmits the message by, for example, transmitting only the least significant bits of the timing information. On the receiving end, the first wireless device 502 may reconstruct the most significant bits of the timing information based on prior coarse positional information.

At 606, one or both of the first timing information and the second timing information may be adjusted to account for relative clock drift between a first clock associated with the first wireless device 502 and a reference clock. The reference clock may be a second clock associated with the second wireless device 504. The reference clock may be selected based on a signaling exchange between the first wireless device 502 and the second wireless device 504. The adjustment based on the relative clock drift may be as described with FIG. 5.

At 608, the range between the first wireless device 502 and the second wireless device 504 based on the first timing information and the second timing information is determined. The clock drift and range may be determined using: low-order model for clock drift, e.g., linear model; low-order model for range, e.g., quadratic model; jointly compute clock drift and range, e.g., weighted local linear regression, such as shown in the equations described in association with FIG. 5.

FIG. 7 is a conceptual data flow diagram 700 illustrating the data flow between different modules/means/components in an exemplary apparatus 702. The apparatus 702 may be a first wireless device configured to estimate a range between itself and a second wireless device 712. In some examples, the apparatus 702 may correspond to the first wireless device 502, and the second wireless device 712 may correspond to the second wireless device 504. The apparatus 702 may perform the operations described in FIGS. 5 and 6, as provided below. The apparatus 702 includes a reception module 704, an obtaining module 706, a range determination module 708, and a transmission module 710.

The reception module 704 receives messages broadcasted by the second wireless device 712 (e.g., second wireless device 504). The transmission module 710 transmits broadcast messages from the first wireless device (e.g., first wireless device 502). In one example, the reception module 704 receives messages transmitted by the second wireless device 504, such as s_{A}(n) and s_{D}(n)−(as described with FIG. 5), and the transmission module 710 transmits broadcast messages to the second wireless device 504, such as t_{A}(n) and t_{D}(n) (as described with FIG. 5).

The obtaining module 706 obtains first timing information related to messages broadcasted by the first wireless device and second timing information related to messages broadcasted by the second wireless device 712 (e.g., operations 602 and 604 described above). The information may be obtained from messages received by the reception module 704. For example, the messages may include timestamps or packets that include the information. The information may also be obtained locally based on the broadcasting of messages by the transmission module 710, or the receiving of messages by the reception module 704. For example, the obtaining module 706 may record the time of departure of messages transmitted by the transmission module 710 or the time of arrival of messages received by the reception module 704.

The range determination module 708 determines the range between the apparatus 702 and the second wireless device 712 based on the first timing information and the second timing information (e.g., operations 606 and 608 described above). For example, the range may be determined using: low-order model for clock drift, e.g., linear model; low-order model for range, e.g., quadratic model; jointly compute clock drift and range, e.g., weighted local linear regression, such as shown in the equations described in association with FIG. 5. In some examples, the range determination module 708 may adjust the one or more of the first timing information and the second timing information to account for relative clock drift (e.g., operation 606).

The apparatus 702 may include additional modules that perform each of the blocks of the algorithm in the aforementioned flow chart of FIG. 6. As such, each block in the aforementioned flow charts of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, 710 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception module 704. In addition, the transceiver 810 receives information from the processing system 814, specifically the transmission module 710, and based on the received information, generates a signal to be applied to the one or more antennas 820.

The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system further includes at least one of the modules 704, 706, 708, and 710. The modules may be software modules running in the processor 804, resident/stored in the computer readable medium/memory 806, one or more hardware modules coupled to the processor 804, or some combination thereof

In one configuration, the apparatus 702/702′ for wireless communication includes means for obtaining first timing information related to messages broadcasted by the first wireless device, and means for obtaining second timing information related to messages broadcasted by the second wireless device. The apparatus 702/702′ for wireless communication further includes means for determining the range between the first wireless device and the second wireless device based on the first timing information and the second timing information.

The aforementioned means may be one or more of the aforementioned modules of the apparatus 702 and/or the processing system 814 of the apparatus 702′ configured to perform the functions recited by the aforementioned means. For example, the means for obtaining first timing information may correspond to the obtaining module 706 together with one or both of the reception module 704 and transmission module 710 which provide messages that include first timing information. Likewise, the means for obtaining second timing information may correspond to the obtaining module 706 together with one or both of the reception module 704 and transmission module 710 which provide messages that include second timing information. The means for determining the range may correspond to the range determination module 708.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of estimating a range between a first wireless device and a second wireless device, comprising:
obtaining a relative clock drift Δ₀₁ between a relative wireless device and the first wireless device, while acceptable communication between the first wireless device and the second wireless device is unavailable;
determining a relative clock drift Δ₂₀ between the second wireless device and the relative wireless device, while acceptable communication between the first wireless device and the second wireless device is unavailable;
estimating a relative clock drift Δ₂₁ between the second wireless device and the first wireless device based on the relative clock drift Δ₀₁ and the relative clock drift Δ₂₀; and
estimating a distance between the first wireless device and the second wireless device based on the relative clock drift Δ₂₁.

2. The method of claim 1, wherein the estimating the distance between the first wireless device and the second wireless device is further based on an exchange of wireless signals between the first wireless device and the second wireless device.

3. The method of claim 1, wherein the obtaining the relative clock drift Δ₀₁ comprises receiving the relative clock drift Δ₀₁ from the relative wireless device.

4. The method of claim 1, wherein the estimating the relative clock drift Δ₂₁ comprises computing:
Δ₂₀·Δ₀₁=Δ₂₁.

5. The method of claim 1, wherein the estimating the relative clock drift Δ₂₁ between the second wireless device and the first wireless device satisfies:
$${Δ}_{{i}_{1} {i}_{L}} = {\prod }_{l = 1}^{L - 1} {Δ}_{{i}_{l} {i}_{l + 1}} ,$$
the i₁−i_{L} being wireless devices including the first wireless device and the second wireless device.

6. The method of claim 1, wherein acceptable communication between the first wireless device and the second wireless device being unavailable is indicated by failing to establish a communication channel between the first wireless device and the second wireless device.

7. The method of claim 1, wherein acceptable communication between the first wireless device and the second wireless device being unavailable is indicated by a communication channel between the first wireless device and the second wireless device experiencing noise exceeding a noise threshold or drops exceeding a drop threshold.

8. An apparatus for estimating a range between a first wireless device and a second wireless device, comprising:
means for obtaining a relative clock drift Δ₀₁ between a relative wireless device and the first wireless device, while acceptable communication between the first wireless device and the second wireless device is unavailable;
means for determining a relative clock drift Δ₂₀ between the second wireless device and the relative wireless device, while acceptable communication between the first wireless device and the second wireless device is unavailable;
means for estimating a relative clock drift Δ₂₁ between the second wireless device and the first wireless device based on the relative clock drift Δ₀₁ and the relative clock drift Δ₂₀; and
means for estimating a distance between the first wireless device and the second wireless device based on the relative clock drift Δ₂₁.

9. The apparatus of claim 8, wherein the means for estimating the distance between the first wireless device and the second wireless device is further configured to be based on an exchange of wireless signals between the first wireless device and the second wireless device.

10. The apparatus of claim 8, wherein the means for obtaining the relative clock drift Δ₀₁ is configured to receive the relative clock drift Δ₀₁ from the relative wireless device.

11. The apparatus of claim 8, wherein the means for estimating the relative clock drift Δ₂₁ between the second wireless device and the first wireless device is configured to compute:
Δ₂₀·Δ₀₁=Δ₂₁

12. The apparatus of claim 8, wherein the means for estimating the relative clock drift Δ₂₁ between the second wireless device and the first wireless device is configured to compute:
$${Δ}_{{i}_{1} {i}_{L}} = {\prod }_{l = 1}^{L - 1} {Δ}_{{i}_{l} {i}_{l + 1}} ,$$
the i₁−i_{L} being wireless devices including the first wireless device and the second wireless device.

13. The apparatus of claim 8, wherein acceptable communication between the first wireless device and the second wireless device being unavailable is indicated by failing to establish a communication channel between the first wireless device and the second wireless device.

14. The apparatus of claim 8, wherein acceptable communication between the first wireless device and the second wireless device being unavailable is indicated by a communication channel between the first wireless device and the second wireless device experiencing noise exceeding a noise threshold or drops exceeding a drop threshold.

15. An apparatus for estimating a range between a first wireless device and a second wireless device, comprising:
a memory; and
at least one processor coupled to the memory and configured to:
obtain a relative clock drift Δ₀₁ between a relative wireless device and the first wireless device, while acceptable communication between the first wireless device and the second wireless device is unavailable;
determine a relative clock drift Δ₂₀ between the second wireless device and the relative wireless device, while acceptable communication between the first wireless device and the second wireless device is unavailable;
estimate a relative clock drift Δ₂₁ between the second wireless device and the first wireless device based on the relative clock drift Δ₀₁ and the relative clock drift A₂₀; and
estimate a distance between the first wireless device and the second wireless device based on the relative clock drift Δ₂₁.

16. The apparatus of claim 15, wherein the at least one processor coupled to the memory is configured to estimate the distance between the first wireless device and the second wireless device based on an exchange of wireless signals between the first wireless device and the second wireless device.

17. The apparatus of claim 15, wherein the at least one processor coupled to the memory is configured to obtain the relative clock drift Δ₀₁ by receiving the relative clock drift Δ₀₁ from the relative wireless device.

18. The apparatus of claim 15, wherein the at least one processor coupled to the memory is configured to estimate the relative clock drift Δ₂₁ by computing:
Δ₂₀·Δ₀₁=Δ₂₁.

19. The apparatus of claim 15, wherein the at least one processor coupled to the memory is configured to estimate the relative clock drift Δ₂₁ between the second wireless device and the first wireless device by computing:
$${Δ}_{{i}_{1} {i}_{L}} = {\prod }_{l = 1}^{L - 1} {Δ}_{{i}_{l} {i}_{l + 1}} ,$$
the i₁−i_{L} being wireless devices including the first wireless device and the second wireless device.

20. The apparatus of claim 15, wherein acceptable communication between the first wireless device and the second wireless device being unavailable is indicated by failing to establish a communication channel between the first wireless device and the second wireless device.

21. The apparatus of claim 15, wherein acceptable communication between the first wireless device and the second wireless device being unavailable is indicated by a communication channel between the first wireless device and the second wireless device experiencing noise exceeding a noise threshold or drops exceeding a drop threshold.

22. A computer-readable medium storing computer executable code for estimating a range between a first wireless device and a second wireless device comprising code for:
obtaining a relative clock drift Δ₀₁ between a relative wireless device and the first wireless device, while acceptable communication between the first wireless device and the second wireless device is unavailable;
determining a relative clock drift Δ₂₀ between the second wireless device and the relative wireless device, while acceptable communication between the first wireless device and the second wireless device is unavailable;
estimating a relative clock drift Δ₂₁ between the second wireless device and the first wireless device based on the relative clock drift Δ₀₁ and the relative clock drift Δ₂₀; and
estimating a distance between the first wireless device and the second wireless device based on the relative clock drift Δ₂₁.

23. The computer-readable medium of claim 22, wherein the estimating the distance between the first wireless device and the second wireless device is further based on an exchange of wireless signals between the first wireless device and the second wireless device.

24. The computer-readable medium of claim 22, wherein the obtaining the relative clock drift Δ₀₁ comprises receiving the relative clock drift Δ₀₁ from the relative wireless device.

25. The computer-readable medium of claim 22, wherein the estimating the relative clock drift Δ₂₁ comprises computing:
Δ₂₀·Δ₀₁=Δ₂₁.

26. The computer-readable medium of claim 22, wherein the estimating the relative clock drift Δ₂₁ between the second wireless device and the first wireless device satisfies:
$${Δ}_{{i}_{1} {i}_{L}} = {\prod }_{l = 1}^{L - 1} {Δ}_{{i}_{l} {i}_{l + 1}} ,$$
the i₁−i_{L} being wireless devices including the first wireless device and the second wireless device.

27. The computer-readable medium of claim 22, wherein acceptable communication between the first wireless device and the second wireless device being unavailable is indicated by failing to establish a communication channel between the first wireless device and the second wireless device.

28. The computer-readable medium of claim 22, wherein acceptable communication between the first wireless device and the second wireless device being unavailable is indicated by a communication channel between the first wireless device and the second wireless device experiencing noise exceeding a noise threshold or drops exceeding a drop threshold.
